(19) United States
(12) Patent Application Publication
(10) Pub. No.: US 2004/0192079 A1
(43) Pub. Date: Sep. 30, 2004

(54) Structure of metal spring plate

(76) Inventors: Wen-Tung Lee, Taoyuan (TW); Yi-Hung Chiang, Taoyuan (TW)

Correspondence Address: P-Two Industries Inc., Junghe, P. O. Box No. 6-57, Taipei, 235, TW

(21) Appl. No.: 10/683,708

(22) Filed: Oct. 14, 2003

(30) Foreign Application Priority Data
Mar. 25, 2003 (TW) 092204655

(51) Int. Cl. H01R 12/00

(52) U.S. Cl. 439/66

(57) ABSTRACT

The invention relates to a structure of a metal spring plate. The opposite edges of a peripheral rim of the metal spring plate are cut straight. The peripheral rim is smoothed out to avoid metal danglers so fatigue fracture due to residual stress won't happen on the metal spring plate after long term wear and tear. Furthermore, a center atop the metal spring plate can be an protrusion or an indentation to enhance feel of response for a cell phone user and to ensure accurate signal input.

### BACKGROUND OF THE INVENTION

(a) Field of the Invention

The invention relates to a structure of metal spring plate, one that is used as a switch on a switch board to connect electricity such that the product life is protracted and that the spring plate also possesses ventilation capability.

(b) Description of the Prior Art

Referring to FIG. 1, buttons (40) on a cell phone are a set of switches. The key technology is to place a metal spring plate (20) in cross-sectional arc shape inside the buttons (40). Using a peripheral rim of the metal spring plate (20) to affix to a negative end (32) of a circuit board (30) of a cell phone to maintain connection while a top of the metal spring plate (20) is a distance away from a positive end (31) so that when the buttons (40) are pressed making the top of the metal spring plate (20) to distort in shape and touching the positive end (31) of the circuit board (30). The negative end (32) of the circuit board (30) in connection with the positive end (31) can conduct electricity and specific input signals. When the pressure on the buttons (40) disappears, the top of the metal spring plate (20) rebounds to its original position of having a distance from the positive end (31) of the circuit board (30).

Obviously, the metal spring plate (20) must bear constant stress and distortion. If there is structural defect on the metal spring plate (20), residual stress and residual strain will form to result in fatigue fracture. Where residual strain is the greatest is the place of crack and fracture. Therefore, in order to prolong the product life of the metal spring plate (20), the structural defect of the metal spring plate (20) must be reduced.

However, referring to FIG. 2, the making of the conventional metal spring plate is first to cut out a forming mold (15) and conveyor holes (18) on a metal strip (10) to form the metal spring plates (20) on the metal strip (10). After passing through a cutting machine to form the final product metal spring plate (20), the finished metal spring plates (20) usually have some metal danglers (21) as shown in FIG. 3 on a rim of the metal spring plate (20). The metal dangler (21) are the structural defects of the metal spring plate (20), easily leading to residual stress and residual strain after long term use. Where the use is most often is where the crack and fracture on the metal spring plate (20) will result thus shortening the product life.

Furthermore, the peripheral rim of the metal spring plate does not have a design of ventilation holes. After pressing, because no air can enter the inside of the metal spring plate (20), vacuum can form and lead to suction phenomenon resulting in improper conductivity and wrong signal input.

In consideration of the above, the invention aims to improve the structure of the metal spring plate (20) to prolong the product life and to avoid suction phenomenon for accurate operation.

### SUMMARY OF INVENTION

The main purpose of the invention is to provide a structure of a metal spring plate on which two opposite edges of the peripheral rim are cut straight. Besides smoothing out the peripheral rim of the metal spring plate to avoid the structural defect of metal danglers, the peripheral rim thus has ventilation slits to prolong product life and to avoid suction phenomenon.

The second goal of the invention is to provide a structure of a metal spring plates. A center atop the metal spring plate is indented upward or downward so that a cell phone user can have a better feel of response for accurate signal input.

To enable a further understanding of the aforesaid objectives and the technological methods of the invention herein, the brief description of the drawings below is followed by the detailed description of the preferred embodiment.

### BRIEF DESCRIPTION OF THE DRAWINGS

FIG. 1 shows a perspective view of a conventional metal spring plate in use on the buttons of a cell phone.

FIG. 2 shows a schematic view of a conventional metal strip forming metal spring plates.

FIG. 3 shows metal danglers on a peripheral rim of a conventional metal spring plate.

FIG. 4-5 shows the first preferred embodiment of schematic views according to the invention.

FIG. 6 shows the second preferred embodiment of a perspective view according to the invention.

FIG. 7 shows a cross-section view according to the invention in FIG. 6.

FIG. 8 shows the second preferred embodiment of a cross-section view in use on the buttons of a cell phone.

FIG. 9 shows the third preferred embodiment of a perspective view according to the invention.

FIG. 10 shows a cross-section view according to the invention in FIG. 9.

FIG. 11 shows the third preferred embodiment of a cross-section view in use on the buttons of a cell phone.

### DETAILED DESCRIPTION OF THE PREFERRED EMBODIMENTS

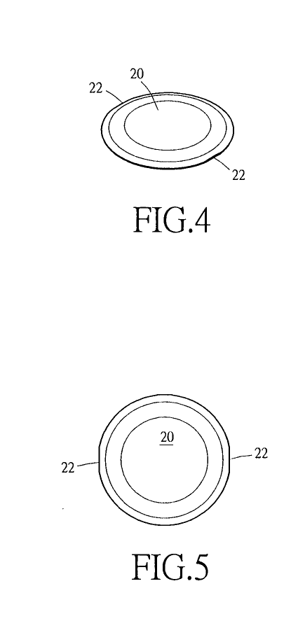

Referring to FIGS. 4-5, the first preferred embodiment of the metal spring plate (20) is arc shaped cross-sectionally. Two opposite edges of a peripheral rim are cut straight (22) for the purpose of smoothing the peripheral rim to avoid structural defect of metal danglers and to form ventilation slits on the metal spring plate (20) by utilizing the bottom of straight edges (22).

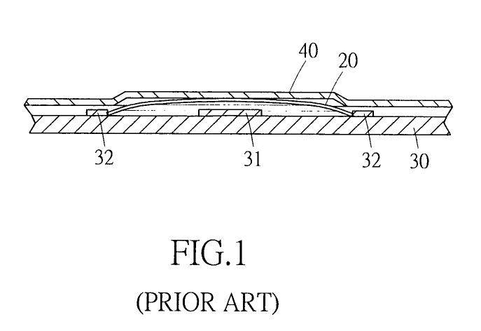

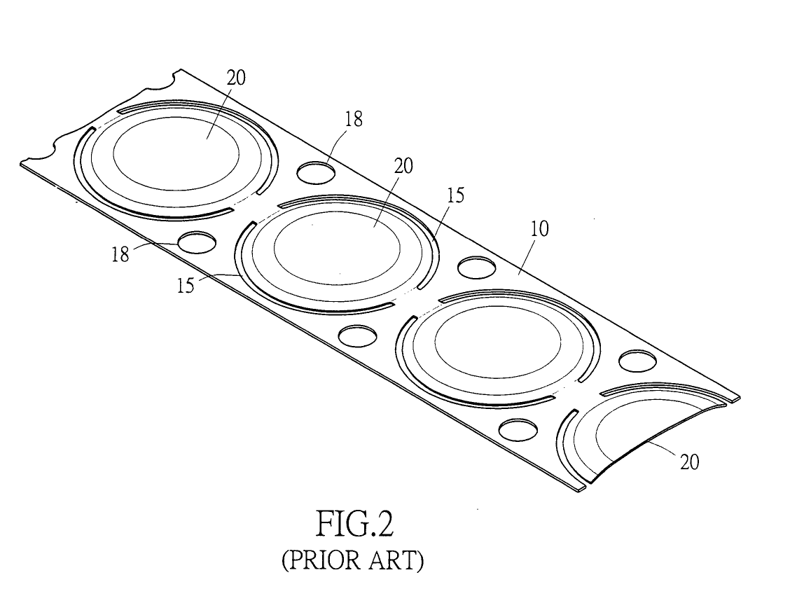

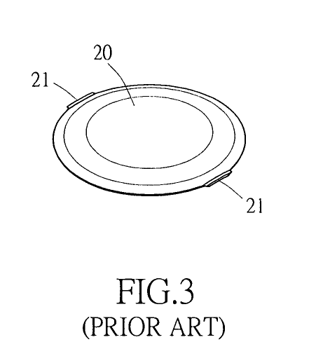

Please refer to FIG. 1 again, due to the elimination of structural defect of the metal spring plate (20), after long term wear and tear, residual stress and metal fatigue fracture can be overcome. So the metal spring plate (20) of the invention does not easily crack or fracture; product life is thus extended.

Also, after the metal spring plate (20) of the invention is pressed, air can pass through the slits through the straight edges (22) to avoid vacuum resulting, meaning that when the metal spring plate (20) of the invention is in use, suction phenomenon won't happen to avoid completely improper electricity conductivity and signal input.

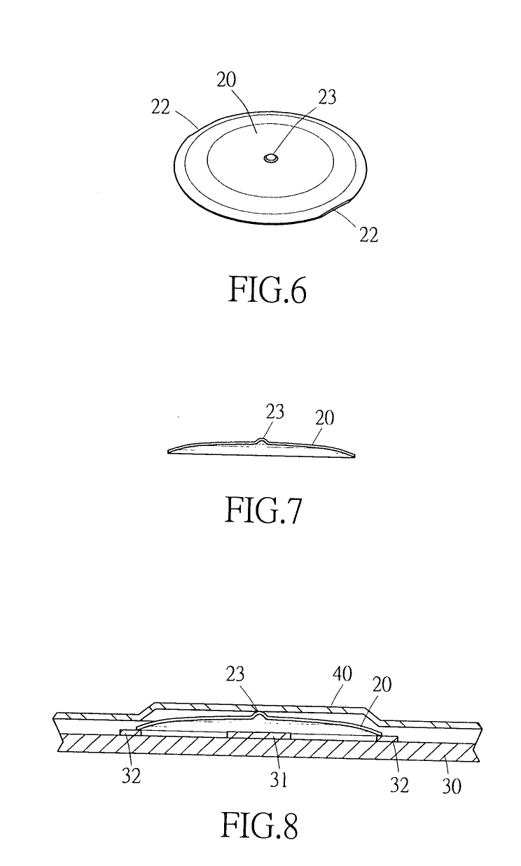

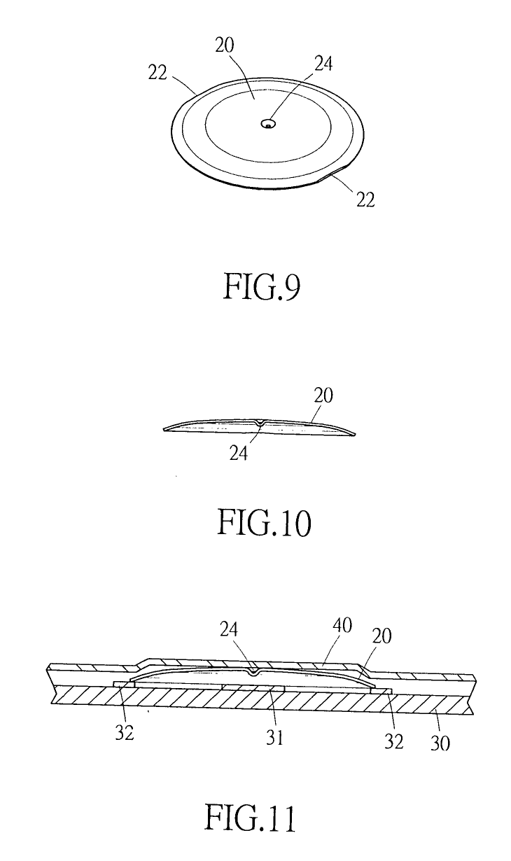

In addition, the invention enhances feel of response when pressing the buttons (40) on a cell phone by an user. The invention also increases conductivity between the negative end (32) and the positive end (31) on the circuit board (30) by using the metal spring plate (20), making signal input on a cell phone more accurate. FIG. 6 and FIG. 9 are the second and third preferred embodiments of the invention.

The second preferred embodiment of the metal spring plate (20) of the invention as shown in FIGS. 6˜7 shows a protrusion (23) at a center atop the metal spring plate (20) besides the peripheral rim of the metal spring plate (20) is being cut straight edges (22). The third preferred embodiment on of the metal spring plate (20) of the invention as shown in FIGS. 9-10 shows an indentation (24) at the center atop the metal spring plate (20) besides the peripheral rim of the metal spring plate (20) is being cut straight edges (22).

### DETAILED DESCRIPTION OF THE PREFERRED EMBODIMENTS

To better understand the characteristics and novelties of the invention, descriptions shall be given with the accompanying drawings hereunder.

Referring to FIGS. 8, the second preferred embodiment of a metal spring plate (20) of the invention in use on the buttons of a cell phone (40), the peripheral rim stays connected to the negative end (32) on the circuit board (30) of a cell phone while the top of the metal spring plate (20) is a distance away from the positive end (31), and the protrusion (23) on the top of the metal spring plate (20) is in touch with the bottom of the buttons (40). When a user presses on the buttons (40), the pressure whereby centering on the protrusion (23) of the metal spring plate (20) so that the metal spring plate can quickly respond to the pressure and distort downwardly touching the positive end (31) on the circuit board (30), thus enhance the feel of response on the buttons (40) for the user who can be assured of the operation done on the buttons (40).

Referring to FIG. 11, the third preferred embodiment of the metal spring plate (20) of the invention in use on the buttons (40) of a cell phone, the indentation (24) of the metal spring plate (20) is a distance away from the positive end (31) on the circuit board. When a user presses on the buttons (40), the top of the metal spring plate (20) distorts downwardly, centering all pressure on the indentation (24) to have the indentation (24) be connected to the positive end (31), conducting both the negative end (32) and the positive end (31) on the circuit board, thus increasing the accuracy of signal input when using a cell phone.

It is of course to be understood that the embodiment described herein is merely illustrative of the principles of the invention and that a wide variety of modifications thereto may be effected by persons skilled in the art without departing from the spirit and scope of the invention as set forth in the claims.

What is claimed is:

1. A metal spring plate comprising:
an arc shaped structure being formed on cross-section of the metal spring plate, wherein two opposite edges of a peripheral rim are cut straight forming ventilation slits at a bottom of straight edges thereof.

2. The metal spring plate as recited in claim 1, wherein a protrusion being formed atop a center of the metal spring plate.

3. The structure of metal spring plate as recited in claim 1, wherein an indentation being formed atop a center of the metal spring plate.
